(19) United States
(12) Patent Application Publication
(10) Pub. No.: US 2007/0269075 A1
(43) Pub. Date: Nov. 22, 2007

(54) Speaker device

(75) Inventor: Toshifumi Kato, Yamagata (JP)

Correspondence Address: NIXON & VANDERHYE, PC, 901 NORTH GLEBE ROAD, 11TH FLOOR, ARLINGTON, VA, 22203, US

(73) Assignees: PIONEER CORPORATION, Tokyo (JP); TOHOKU PIONEER CORPORATION, Yamagata (JP)

(21) Appl. No.: 11/798,778

(22) Filed: May 16, 2007

(30) Foreign Application Priority Data
May 17, 2006 (JP) 2006-137339

(51) Int. Cl. H04R 1/02

(52) U.S. Cl. 381/394

(57) ABSTRACT

A speaker device includes a speaker device terminal including a pair of terminal metals and a terminal metal mounting part on which the pair of terminal metals are mounted, and a frame including a terminal mounting part on which the speaker device terminal is mounted. The terminal mounting part is provided on a rear side of the frame positioned on a side opposite to a sound output side. The speaker device terminal is mounted on the terminal mounting part in such a state that the pair of terminal metals are mounted on the terminal metal mounting part positioned on the side opposite to the sound output side. The terminal metal mounting part has a projecting part, projecting on the side opposite to the sound output side. A height of the projecting part in the projecting direction is higher than heights of the pair of terminal metals in the projecting direction.

### BACKGROUND OF THE INVENTION

1. Field of the Invention

The present invention relates to a protecting configuration of a speaker device terminal for a speaker device.

2. Description of Related Art

Conventionally, a speaker device includes a speaker device terminal to which a sound signal outputted from an amplifier is inputted. Namely, the speaker device terminal serves as a relay terminal which electrically connects an output wiring of the amplifier and a voice coil. The speaker device terminal is normally mounted on a frame positioned on a rear side of the speaker device.

In this manner, if the speaker device terminal is arranged on the rear side of the speaker device, when the speaker device is mounted on a mounting base such as an inner panel of a vehicle, the speaker device terminal easily collides against the mounting base. Thus, a manufacturer accidentally hits the speaker device terminal against the mounting base at the mounting time, which may break the speaker device terminal.

Particularly, since the speaker device terminal has an important role as the relay terminal electrically connected to the voice coil and the amplifier as described above, it is desired that the speaker device has a protecting configuration capable of preventing the damage of the speaker device terminal due to the mechanical collision.

As a speaker device for solving the problem of this kind, there is proposed a speaker device having a configuration capable of preventing a terminal (speaker device terminal) from receiving the mechanical damage, for example (see Japanese Patent Application Laid-open under No. 8-70495 (Reference-1)).

In the speaker device according to Reference-1, the terminal is integrated with a part of a slope part on the rear side of the frame, and a reversed-L-shaped bridge is provided in the vicinity of the terminal. The bridge projects on the rear side of the frame over an outside diameter size of the terminal to cover the terminal. Thereby, the bridge structurally covers the terminal, which can prevent the terminal from receiving the mechanical damage.

An example of a speaker device having a configuration capable of preventing buckling of a coil spring terminal is disclosed in Japanese Patent Application Laid-open under No. 2005-86770. Moreover, an example of a speaker device having a configuration capable of preventing water from entering a connection part of a lead wire is disclosed in Japanese Patent Application Laid-open under No. 2003-102089.

However, the speaker device according to Reference-1 has to include the bridge having a complex shape on the rear side of the frame in order to protect the terminal from the mechanical damage. Therefore, a configuration of a metal mold for forming the frame problematically becomes complex in order to form the bridge. Particularly, when the frame is made of a metal, the problem becomes more significant.

Thus, so as to solve the problem, it is preferable that the terminal is protected from the mechanical collision by improving not the configuration of the frame but the configuration of the terminal itself.

### SUMMARY OF THE INVENTION

The present invention has been achieved in order to solve the above problem. It is an object of this invention to provide a speaker device capable of protecting a speaker device terminal from mechanical collision by improving a configuration of the speaker device terminal.

According to one aspect of the present invention, there is provided a speaker device including: a speaker device terminal including a pair of terminal metals and a terminal metal mounting part on which the pair of terminal metals are mounted; and a frame including a terminal mounting part on which the speaker device terminal is mounted, wherein the terminal mounting part is provided at a part of the frame positioned on a side opposite to a sound output side, wherein the speaker device terminal is mounted on the terminal mounting part in such a state that the pair of terminal metals are mounted on the terminal metal mounting part positioned on the side opposite to the sound output side, wherein the terminal metal mounting part has a terminal metal protecting part projecting on the side opposite to the sound output side, and wherein a height of the terminal metal protecting part in the projecting direction is higher than heights of the pair of terminal metals in the projecting direction.

The above speaker device includes the speaker device terminal including the pair of terminal metals electrically connected to a pair of plus and minus output wirings of an amplifier and each lead wire of a pair of plus and minus lead wires of a voice coil and the terminal metal mounting part on which the pair of terminal metals are mounted; and the frame including the terminal mounting part on which the speaker device terminal is mounted. The terminal mounting part is provided at the part of the frame positioned on the side opposite to the sound output side, and the speaker device terminal is mounted on the terminal mounting part in such a state that the pair of terminal metals are mounted on the terminal metal mounting part positioned on the side opposite to the sound output side.

Particularly, the terminal metal mounting part has the terminal metal protecting part, serving as a projecting part, projecting on the side opposite to the sound output side, and the height of the terminal metal protecting part in the projecting direction is higher than the heights of the pair of terminal metals in the projecting direction.

In a preferred example, in a case that a contact surface of the terminal metal mounting part contacting the pair of terminal metals is prescribed as a reference surface, a height from the reference surface to one end of the terminal metal protecting part positioned at a position farthest in the projecting direction may be higher than a height from the reference surface to each one end of the pair of terminal metals positioned at a position farthest in the projecting direction.

Thereby, when the manufacturer mounts the speaker device on a mounting base by moving the rear side of the speaker device positioned on the side opposite to the sound output side to the mounting base of an inner panel of a vehicle and inserting a part of the rear side into an opening provided on the mounting base, even if he or she accidentally hits the speaker device terminal against the mounting base, the component of the speaker device terminal mechanically colliding against the mounting base is not the pair of terminal metals but the terminal metal protecting part. Therefore, it can be prevented that the pair of terminal metals serving as the relay terminal electrically connected to the voice coil and the amplifier are damaged. In this manner, since the terminal metal protecting part has the function to protect the pair of terminal metals from the mechanical collision, even when the mechanical collision between the speaker device terminal and the mounting base occurs, it can be prevented that the pair of terminal metals having an important function to transmit a sound signal from the amplifier to the voice coil are crucially damaged.

Additionally, by employing the configuration, the configuration for protecting the speaker device terminal does not have to be formed on the frame, as a secondary effect. Thus, the configuration of the terminal mounting part of the frame can be simplified, and the configuration of a metal mold for forming the frame can be correspondently simplified.

In a manner of the above speaker device, a relative positional relation between an end part of the terminal metal protecting part and each end part of the pair of terminal metals may be defined so that the end part of the terminal metal protecting part positioned at a position outwardly farthest from a center of the frame is positioned on an outer side with respect to each end part of the pair of terminal metals positioned at a position outwardly farthest from the center of the frame.

Now, a speaker device terminal according to a comparative example will be assumed. The speaker device terminal has such a configuration that the relative positional relation between the end part of the terminal metal protecting part and each end part of the pair of terminal metals is defined so that the end part of the terminal metal protecting part positioned at a position outwardly farthest from the center of the frame is positioned on the inner side with respect to each end part of the pair of terminal metals positioned at a position outwardly farthest from the center of the frame. In the comparative example, when the manufacturer accidentally hits the speaker device terminal against the mounting base at the time of mounting of the speaker device on the mounting base, the mechanical collision between the mounting base and the pair of terminal metals may occur. In this case, the pair of terminal metals may be damaged.

On the other hand, in this manner, the relative positional relation between the terminal part of the terminal metal protecting part and each end part of the pair of terminal metals is defined so that the end part of the terminal metal protecting part positioned at the position outwardly farthest from the center of the frame is positioned on the outer side with respect to each end part of the pair of terminal metals positioned at the position outwardly farthest from the center of the frame.

Therefore, even when the manufacturer accidentally hits the speaker device terminal against the mounting base at the time of mounting of the speaker device on the mounting base, the component of the speaker device terminal mechanically hitting against the mounting base is not the pair of terminal metals but the terminal metal protecting part. Hence, it can be prevented that the pair of terminal metals serving as the relay terminal electrically connected to the voice coil and the amplifier are damaged.

In a preferred example, the terminal metal mounting part may be preferably made of a resin material. This is because, if the terminal metal mounting part is made of the resin material, the terminal metal protecting part can be easily formed by a general forming method of the resin manufacture.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIGS. 1A and 1B show a front view and a rear view of a speaker device including a speaker device terminal according to an embodiment of the present invention;

FIGS. 2A and 2B show various kinds of side views of the speaker device including the speaker device terminal according to the embodiment;

FIG. 3 shows a cross-sectional view of the speaker device including the speaker device terminal according to the embodiment when cut at a position passing through a central axis thereof;

FIGS. 4A to 4c show a front view and various kinds of side views of the speaker device terminal according to the embodiment;

FIGS. 5A to 5D show a front view, a rear view and various kinds of side views of a terminal metal mounting part of the speaker device terminal according to the embodiment;

FIGS. 6A to 6D show another side view and another cross-section view of the terminal metal mounting part of the speaker device terminal according to the embodiment, and a front view and a cross-sectional view of an integration member of the speaker device terminal;

FIG. 7 shows a main part perspective view of the speaker device including the speaker device terminal according to a comparative example when observed from the rear side;

FIGS. 8A and 8B are process views showing such a state that the speaker device including the speaker device terminal according to the comparative example is mounted on a mounting base;

FIGS. 9A and 9B are process views showing such a state that the speaker device including the speaker device terminal according to another comparative example is mounted on the mounting base;

FIGS. 10A and 10B show a process view showing such a state that the speaker device including the speaker device terminal according to the embodiment is mounted on the mounting base and an enlarged main part side view of the speaker device terminal;

FIGS. 11A to 11C show a perspective view, a front view and a rear view of the speaker device terminal according to a modification;

FIGS. 12A to 12C show various kinds of side views and a cross-sectional view of the speaker device terminal according to the modification; and

FIG. 13 shows a main part perspective view of the speaker device including the speaker device terminal according to the modification when observed from the rear side.

### DETAILED DESCRIPTION OF THE PREFERRED EMBODIMENTS

Now, a preferred embodiment of the present invention will be described below with reference to the attached drawings.

### [Configuration of Speaker Device]

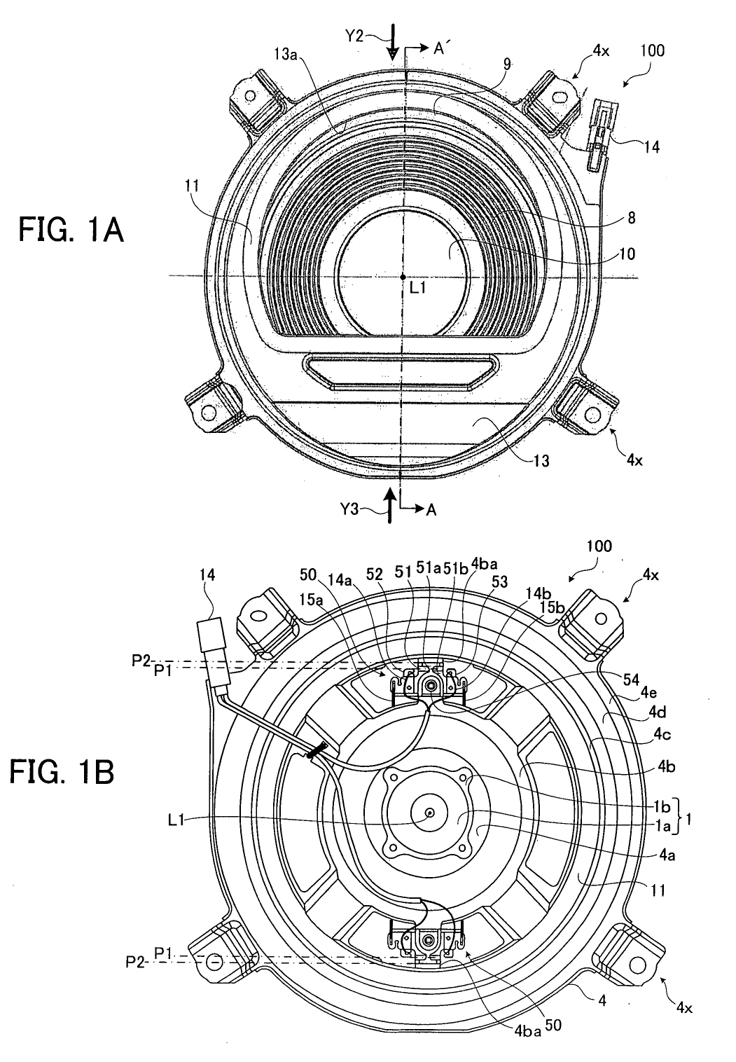

First, a description will be given of a configuration of a speaker device 100 including a speaker device terminal 50 according to an embodiment of the present invention, with reference to FIGS. 1A and 1B to FIG. 3.

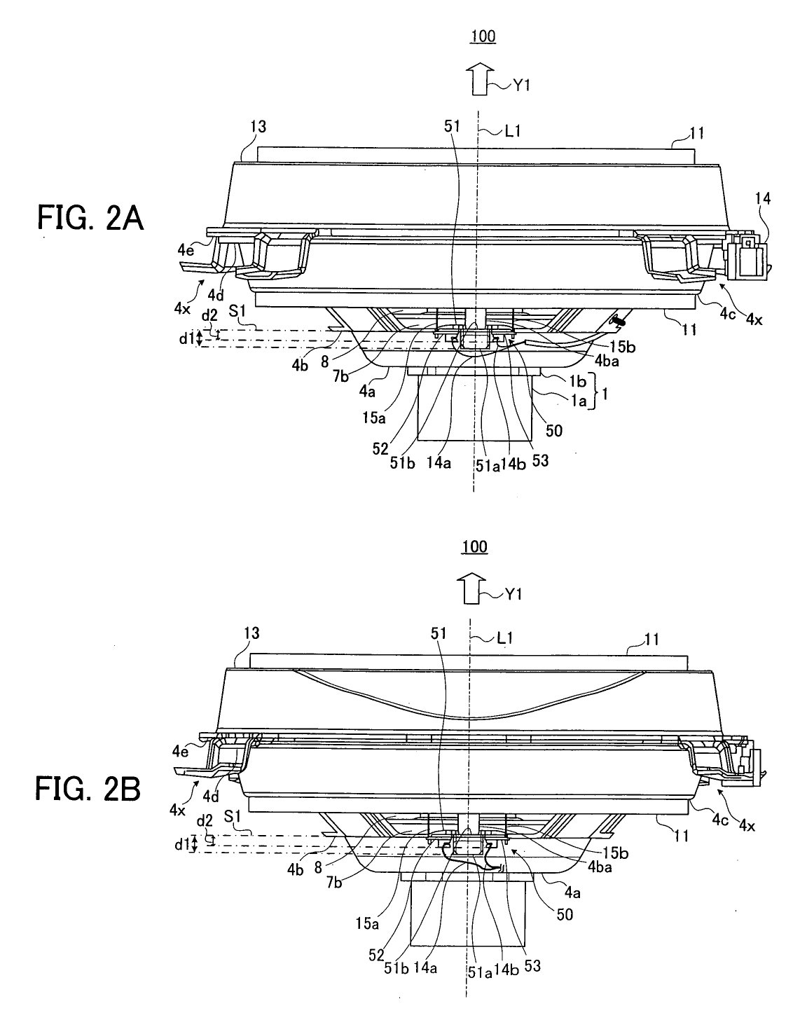

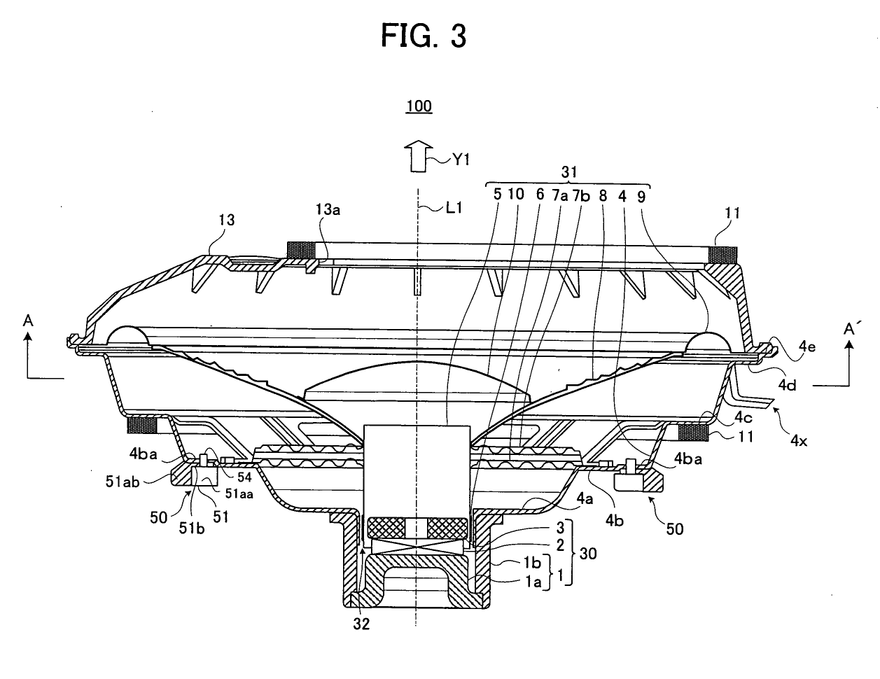

FIG. 1A shows a front view of the speaker device 100 when observed from the sound output direction. FIG. 1B shows a rear view of the speaker device 100 when observed from a side opposite to the sound output direction. FIG. 2A shows a side view of the speaker device 100 when observed from a direction of an arrow Y2 shown in FIG. 1A. FIG. 2B shows a side view of the speaker device 100 when observed from the direction (the direction opposite to the arrow Y2 direction) of an arrow Y3 shown in FIG. 1A. FIG. 3 shows a cross-sectional view of the speaker device 100 when taken along a plan view passing through a central axis L1 thereof.

The speaker device 100 includes a magnetic circuit 30, a vibration system member 31 and other component members for a speaker device. The other component members for the speaker device are the speaker device terminal 50, a buffer member 11 and a cover 13. In the present invention, the configuration and the driving system of the speaker device are not limited to a manner explained below.

### (Configuration of Magnetic Circuit)

A configuration of the magnetic circuit 30 will be described below.

The magnetic circuit 30, configured as an external-magnet-type magnetic circuit, includes a yoke 1 having a first yoke la for mounting a magnet 2 and a second yoke 1b for supporting a frame 4, integrated with the first yoke 1a; the magnet 2; and a plate 3. In the present invention, the magnetic circuit may be an internal-magnet-type magnetic circuit.

The first yoke 1a has a substantially cylindrical shape and a projecting cross-section. The magnet 2 is mounted on the upper surface of the first yoke 1a. The second yoke 1b, having a substantially cylindrical shape, is positioned at a position covering the first yoke 1a. The vicinity of the lower end part of the inner peripheral wall of the second yoke 1b is integrated with the vicinity of the lower end part of the outer peripheral wall of the first yoke 1a. In this manner, the yoke 1 is formed. The magnet 2, having a disc shape, is mounted on the upper surface of the first yoke 1a. The plate 3, having a disc shape, is mounted on the magnet 2. An opening, provided at a substantially central position of the plate 3, has a function to externally radiate the heat which occurs in the magnetic circuit 30 and cool the magnetic circuit 30. A magnetic gap 32 on which the magnetic flux of the magnet 2 concentrates is formed between the outer peripheral wall of the plate 3 and the vicinity of the upper end part of the inner peripheral wall of the second yoke 1b.

### (Configuration of Vibration System Member)

Next, the configuration of the vibration system member will be explained below.

The vibration system member includes the frame 4, a voice coil bobbin 5, a voice coil 6, a first damper 7a, a second damper 7b, a diaphragm 8 and an edge 9.

The frame 4, having a substantially bowl shape and a step cross-section, has a function to support various kinds of components of the speaker device 100. The frame 4 includes a first step part 4a provided on the lower end part thereof, a second step part 4b provided above and on the outer side of the first step part 4a, a third step part 4c provided above and on the outer side of the second step part 4b, a fourth step part 4d provided above and on the outer side of the third step part 4c, a fifth step part 4e provided above and on the outer side of the fourth step part 4d, and plural speaker mounting parts 4x for mounting the speaker device 100 on an inner panel of a vehicle.

The first step part 4a is mounted on the upper end surface of the second yoke 1b. Thereby, the frame 4 is integrated with the magnetic circuit 30. Each outer peripheral part of the first damper 7a and the second damper 7b is mounted on the upper surface of the second step part 4b positioned on the sound output side, and the second step part 4b has a function to support the first damper 7a and the second damper 7b. In addition, terminal mounting parts 4ba on which the speaker device terminal 50 is mounted are provided at an appropriate position of the second step part 4b. In this embodiment, two terminal mounting parts 4ba are provided at positions opposite to each other. The speaker device terminal 50 is mounted on each of the terminal mounting parts 4ba in such a state that a pair of terminal metals 52 and 53 are mounted on a terminal metal mounting part (terminal board) 51 positioned opposite to the sound output side. The detailed configuration of the speaker device terminal 50 will be explained later. A pole-state buffer member 11, which is deformed into an annular shape, is attached to the rear surface of the third step part 4c positioned opposite to the sound output side. The outer peripheral part of the edge 9 is mounted on the upper surface of the fourth step part 4d, which has a function to support the edge 9. The cover 13 is mounted on the upper surface of the fifth step part 4e. Each of the speaker mounting parts 4x is provided on the upper end side of the frame 4 with an appropriate space therebetween.

The voice coil bobbin 5 has a substantially cylindrical shape, and the vicinity of the lower end part of the inner peripheral wall thereof covers a part of the magnet 2 and the plate 3. The voice coil 6 is wound around the vicinity of the lower end part of the outer peripheral wall of the voice coil bobbin 5. The voice coil 6 has two pairs of plus and minus lead wirings (not shown). In this invention, the voice coil 6 may have a set of (or a pair of) plus and minus lead wiring. The plus lead wiring is an input wiring of an L (or R) channel signal, and the minus lead wiring is an input wiring of a ground (GND:ground) signal. Each of the minus and plus (or plus and minus) lead wirings is electrically connected to each end side of tinsel cords 15a and 15b drawn to the sound output surface of the diaphragm 8 positioned on the sound output side, and each of the other sides of the tinsel cords 15a and 15b is electrically connected to the pair of terminal metals 52 and 53 of the speaker device terminal 50. Additionally, each of the pair of terminal metals 52 and 53 is electrically connected to plus and minus (or minus and plus) relay wirings 14a and 14b of a connector 14 electrically connected to each of the plus and minus (or minus and plus) output wirings on the side of an amplifier (not shown). By this connection structure, 2-channel signals and power (hereinafter simply referred to as “sound current”, too) are inputted into the voice coil 6 from the amplifier.

Each of the first damper 7a and the second damper 7b, having an elastic part formed with plural concentric corrugations, has a function to elastically support the voice coil bobbin 5. The inner peripheral edge part of the first damper 7a is mounted on the vicinity of the central part of the outer peripheral wall of the voice coil bobbin 5, and the outer peripheral part of the first damper 7a is mounted on the second step part 4b of the frame 4. The second damper 7b is arranged above the first damper 7a. The inner peripheral edge part of the second damper 7b is mounted on the vicinity of the upper end part of the outer peripheral wall of the voice coil bobbin 5, and the outer peripheral part of the second damper 7b is mounted on the second step part 4b of the frame 4. Therefore, the speaker device 100 has a double-damper configuration. Instead, in the present invention, the speaker device 100 may have a single-damper configuration with one damper.

The diaphragm 8, having a cone shape, has a function to output the acoustic wave corresponding to the sound current inputted to the voice coil 6. The inner peripheral edge part of the diaphragm 8 is mounted on the upper end portion of the outer peripheral wall of the voice coil bobbin 5. The inner peripheral part of the edge 9 for absorbing an unnecessary vibration occurring on the diaphragm 8 is mounted on the outer peripheral edge part of the diaphragm 8, and the outer peripheral part of the edge 9 is mounted on the fourth step part 4d of the frame 4. In this embodiment, the diaphragm 8 and the edge 9 are separately and independently formed. However, this invention is not limited to this. Namely, in the present invention, the diaphragm 8 and the edge 9 may be integrally formed.

The cap 10, formed into a dome shape, has a function to prevent dust and water drop from entering the magnetic circuit 30. The outer peripheral part of the cap 10 is mounted on the vicinity of the inner peripheral part on the diaphragm 8, and the cap 10 covers the upper surface of the voice coil bobbin 5.

The cover 13, having a cylindrical shape, has an half-circle opening 13a for making the acoustic wave outputted from the diaphragm 8 pass to the external, and the peripheral end surface of the cover 13 positioned on the side opposite to the sound output side is mounted on the fifth step part 4e of the frame 4. The pole-state buffer member 11 deformed into the annular shape is attached to the peripheral edge of the opening 13a being the upper surface of the cover 13 positioned on the sound output side.

In the speaker device 100 having the above-mentioned configuration, the sound current outputted from the amplifier is inputted to the voice coil 6 via the relay wirings 14a and 14b of the connector 14, the pair of terminal metals 52 and 53 of each speaker terminal 50, each of the tinsel cords 15a and 15b and the pair of plus and minus lead wirings of the voice coil 6. Thereby, in accordance with Fleming's left-hand rule, the driving force is generated to the voice coil 6 in the magnetic gap 32, which vibrates the diaphragm 8 to the direction of the central axis L1 of the speaker device 100. In this manner, the speaker device 100 outputs the acoustic wave in the arrow Y1 direction via the diaphragm 8.

### [Configuration of Speaker Device Terminal]

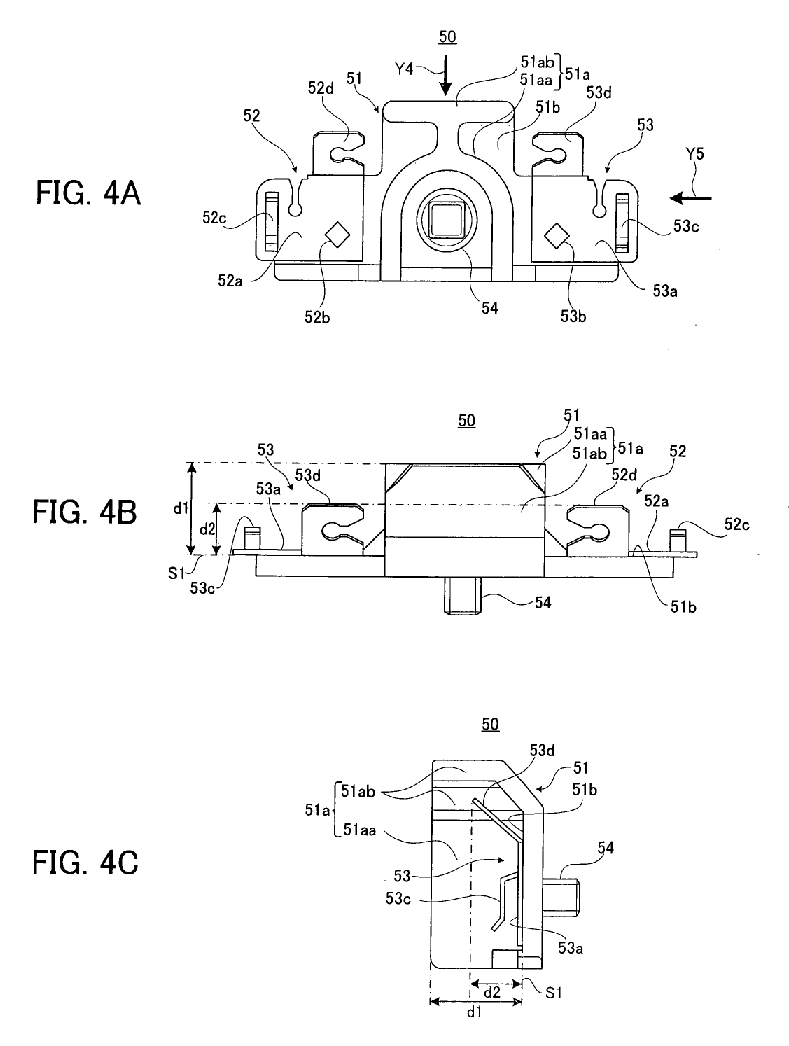

Next, a description will be given of the configuration of the speaker device terminal 50 according to the embodiment of the present invention, with reference to FIGS. 4A to 4C to FIGS. 6A to 6D.

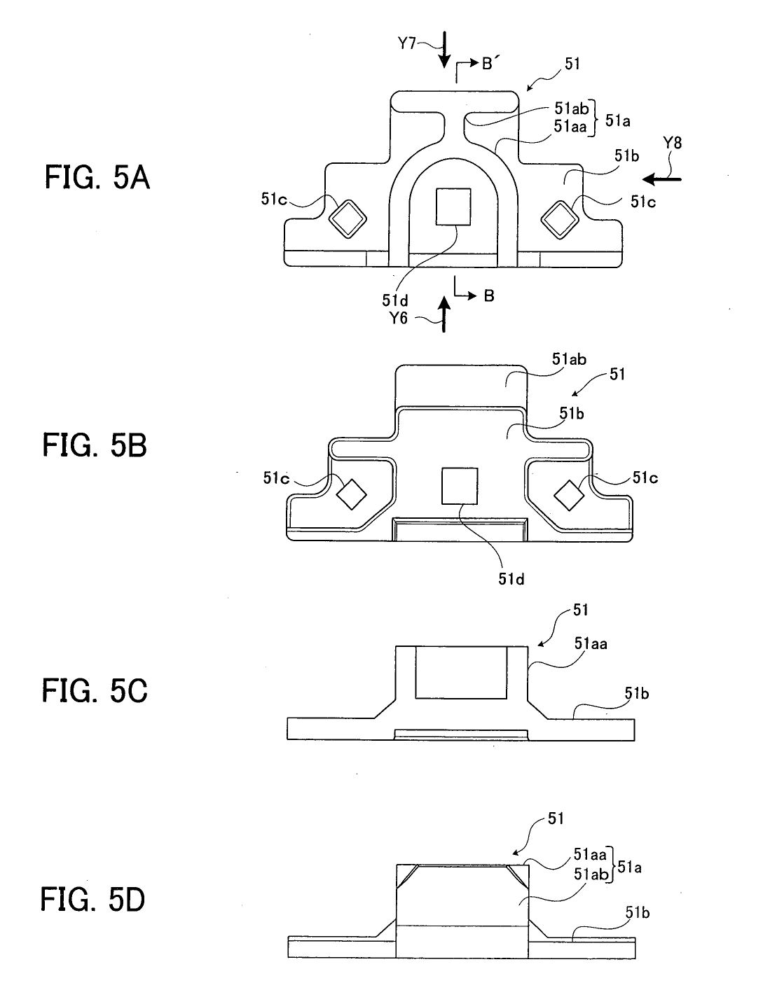

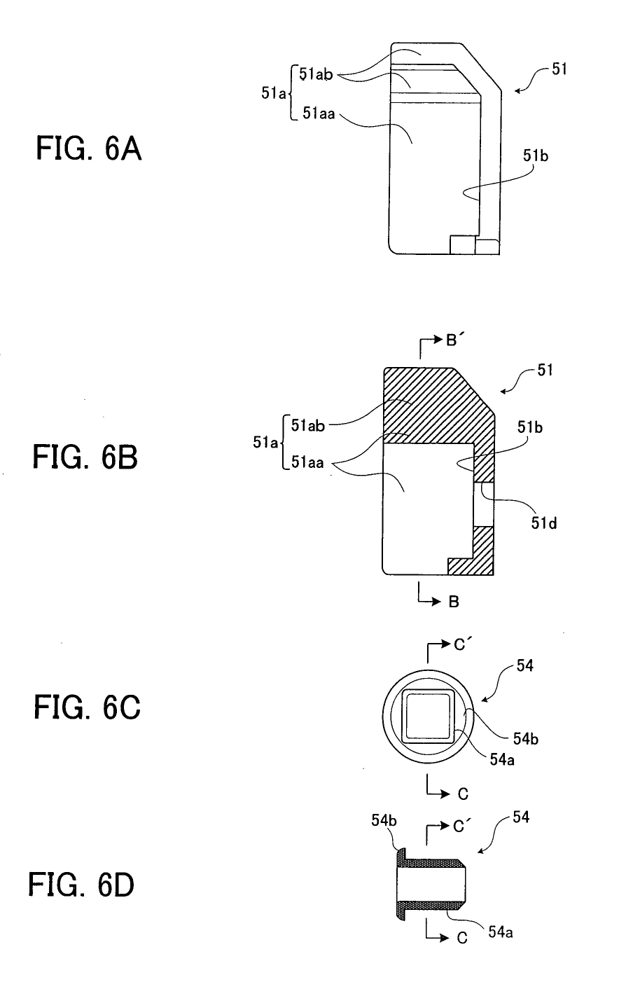

FIG. 4A shows a front view of the speaker device terminal 50. FIG. 4B shows a side view of the speaker device terminal 50 when observed from the direction of an arrow Y4 shown in FIG. 4A. FIG. 4C shows a side view of the speaker device terminal 50 when observed from the direction of an arrow Y5 shown in FIG. 4A. FIG. 5A shows a front view of a terminal metal mounting part 51 being the component of the speaker device terminal 50. FIG. 5B shows a rear view of the terminal metal mounting part 51. FIG. 5C shows a side view of the terminal metal mounting part 51 when observed from the direction of an arrow Y6 shown in FIG. 5A. FIG. 5D shows a side view of the terminal metal mounting part 51 when observed from the direction of an arrow Y7 shown in FIG. 5A. FIG. 6A shows a side view of the terminal metal mounting part 51 when observed from the direction of the arrow Y8 shown in FIG. 5A. FIG. 6B is a cross-sectional view of the terminal metal mounting part 51 taken along a cutting line B-B′ shown in FIG. 5A, which shows a cross-sectional view cut at a position passing through the center in the longitudinal direction of the terminal metal mounting part 51. FIG. 6C shows a front view of an integration member (eyelet) 54 being the component of the speaker device terminal 50. FIG. 6D is a cross-sectional view of an integration member 54 taken along a cutting line C-C′ shown in FIG. 6C, which is a cross-sectional view cut at a position passing through the central axis of the integration member 54.

The speaker device terminal 50 includes the pair of terminal metals 52 and 53, the terminal metal mounting part 51 on which the pair of terminal metals 52 and 53 are mounted, the integration member 54 for integrating the terminal metal mounting part 51 with the terminal mounting part 4ba of the frame 4.

The terminal metal mounting part 51, having a step and substantially mountain plane shape, is made of a resin material. The terminal metal mounting part 51 includes a base part 51b having flatness, an insertion hole 51d into which the integration member 54 is inserted, provided at the substantially middle position of the base part 51b, a first projecting part 51aa, projecting from the base part 51b, provided at a position surrounding the insertion hole 51d and having a U-shaped plane shape, a second projecting part 51ab, projecting from the base part 51b, provided at a position joining to a part of the first projecting part 51aa and having a T-shaped plane shape, and plural openings 51c into which an integration part 52b of the terminal metal 52 and an integration part 53b of the terminal metal 53 are inserted, provided at a position sandwiching the first projecting part 51aa and on both sides thereof. In this specification, the component formed by integrating the first projecting part 51aa and the second projecting part 51ab is simply referred to as “projecting part (terminal metal protecting part) 51a”, too.

The pair of terminal metals 52 and 53, made of a metallic material, have symmetrical shapes. The terminal metal 52 includes a flat plate part 52a having a flat plate shape, an integration part 52b, projecting from a predetermined position of the flat plate part 52a to the side of the terminal metal mounting part 51 and integrating the terminal metal 52 and the terminal metal mounting part 51, a first connection part 52c, provided on the one end side of the flat plate part 52a and electrically connected to the tinsel cord 15a electrically connected to the plus (or minus) lead wiring of the voice coil 6, a second connection part 52d, folded to obliquely upwardly project from the other end side adjacent to the one end side of the flat plate part 52a and project on the side opposite to the terminal metal mounting part 51, and electrically connected to the plus (or minus) relay wiring 14a of the connector 14. Meanwhile, the terminal metal 53 has the same components as those of the terminal metal 52. Concretely, the terminal metal 53 includes a flat plate part 53a having a flat plane shape, an integration part 53b, projecting from a predetermined position of the flat plate part 53a to the side of the terminal metal mounting part 51 and integrating the terminal metal 53 and the terminal metal mounting part 51, a first connection part 53c, provided on the one end side of the flat plate part 53a and electrically connected to the tinsel cord 15b electrically connected to the minus (or plus) lead wiring of the voice coil 6, and a second connection part 53d, folded to obliquely upwardly project from the other end side adjacent to the one end side of the flat plate part 53a and project on the side opposite to the terminal metal mounting part 51, and electrically connected to the minus (or plus) relay wiring 14b of the connector 14.

The pair of terminal metals 52 and 53 having the above-mentioned configurations are arranged at the position sandwiching the first projecting part 51aa of the terminal metal mounting part 51 and on both sides thereof, respectively. The surfaces of the flat plate part 52a of the terminal metal 52 and the flat plate part 53a of the terminal metal 53 contact with the surfaces of the base part 51b, respectively. The integration part 52b of the terminal metal 52 and the integration part 53b of the terminal metal 53 are inserted into the correspondent openings 51c, and they are caulked to the correspondent base parts 51b, respectively. In this manner, the pair of terminal metals 52 and 53 are mounted on the base part 51b in such a state that they mutually sandwich the first projecting part 51aa.

In this state, in a case that the contact surface between the pair of terminal metals 52 and 53 and the base part 51b of the terminal metal mounting part 51 is prescribed as a reference surface S1, a height h1 of the projecting part 51a in the projecting direction from the reference surface S1 is higher than a height d2 of the pair of terminal metals 52 and 53 in the projecting direction from the reference surface S1. Namely, the height d1 to the end of the projecting part 51a positioned at the position farthest in the projecting direction from the reference surface S1 is higher than the height d2 to each end of the pair of terminal metals 52 and 53 positioned at the position farthest in the projecting direction from the reference surface S1.

The integration member 54 includes a cylindrical part 54a having a cylindrical shape and a flange part 54b outwardly extending from the one end side of the outer peripheral wall of the cylindrical part 54a. The cylindrical part 54a is inserted into the insertion hole 51d of the terminal metal mounting part 51, and the flange part 54b contacts with a part of the upper surface of the base part 51b.

Each of the speaker device terminals 50 having the above-mentioned configuration is mounted on the terminal mounting part 4ba of the frame 4 via each of the integration member 54, in such a state that the pair of terminal metals 52 and 53 are mounted on the terminal metal 51 positioned on the side opposite to the sound output side (the arrow Y1 direction), as shown in FIGS. 1A and 1B to FIG. 3.

Next, a description will be given of characteristic operation and effect of the speaker device 100 having the speaker device terminal 50 according to the embodiment of the present invention, as compared with the comparative example. In the explanation of the comparative example, the same reference numerals are given to the same components as those of the embodiment, and explanations thereof are simplified or omitted.

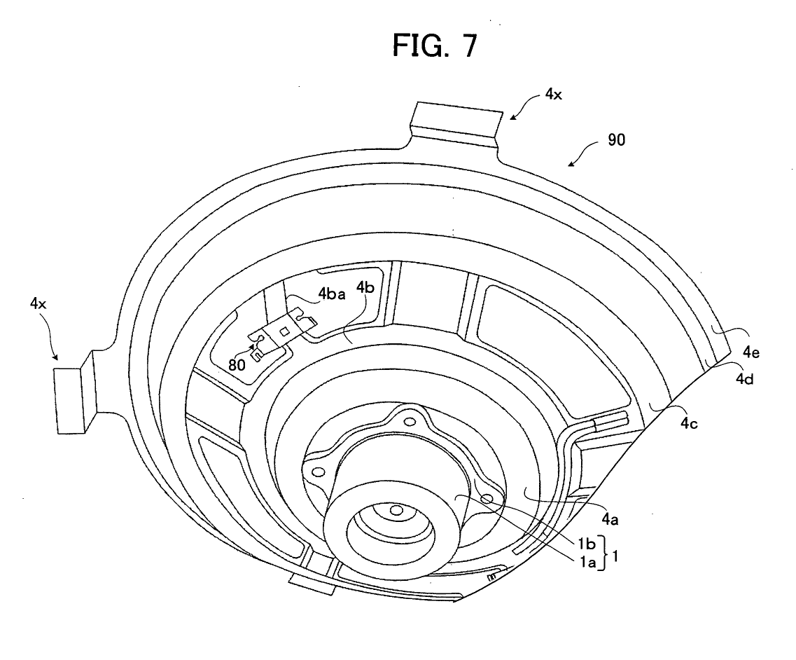

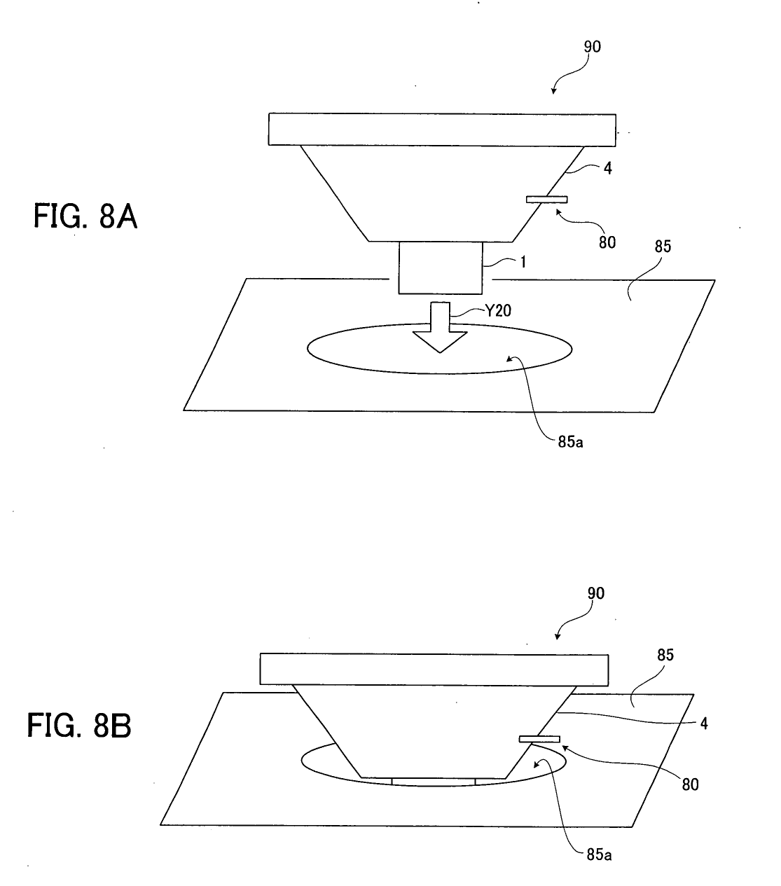

FIG. 7 shows a main part perspective view of a speaker device 90 having a speaker device terminal 80 according to the comparative example when observed from the rear side. FIGS. 8A and 8B are process views schematically showing such a state that the speaker device 90 having the speaker device terminal 80 is mounted on the mounting base.

When the comparative example and the embodiment are compared, they are different in the configuration of the speaker device terminal. However, the other components of them are same. The speaker device terminal 80 according to the comparative example is made of the metallic material, and it does not have the projecting part 51a according to the embodiment. Namely, the speaker device terminal 80 according to the comparative example corresponds to the pair of terminal metals 52 and 53 of the present invention. In the case of the comparative example having the configuration, when the manufacturer accidentally hits the speaker device terminal 80 against the mounting base 85 at the time of mounting the speaker device 90 on the mounting base 85 such as the inner panel of the vehicle, the mechanical collision between the mounting base 85 and the speaker device terminal 80 may occur. In this case, the speaker device terminal 80 may be damaged.

Namely, as shown in FIG. 8A, when the manufacturer moves the rear side of the speaker device 90 having the speaker device terminal 80 to the side of the mounting base 85 in the direction of an arrow Y20 and inserts the part of the rear side of the speaker device 90 into the opening 85a provided on the mounting base 85, the manufacturer hits the speaker device terminal 80 mounted on the frame 4 against the mounting base 85, as shown in FIG. 8B. It is problematic that the speaker device terminal 80 having the important function as the relay terminal electrically connected to the voice coil 6 and the amplifier is damaged.

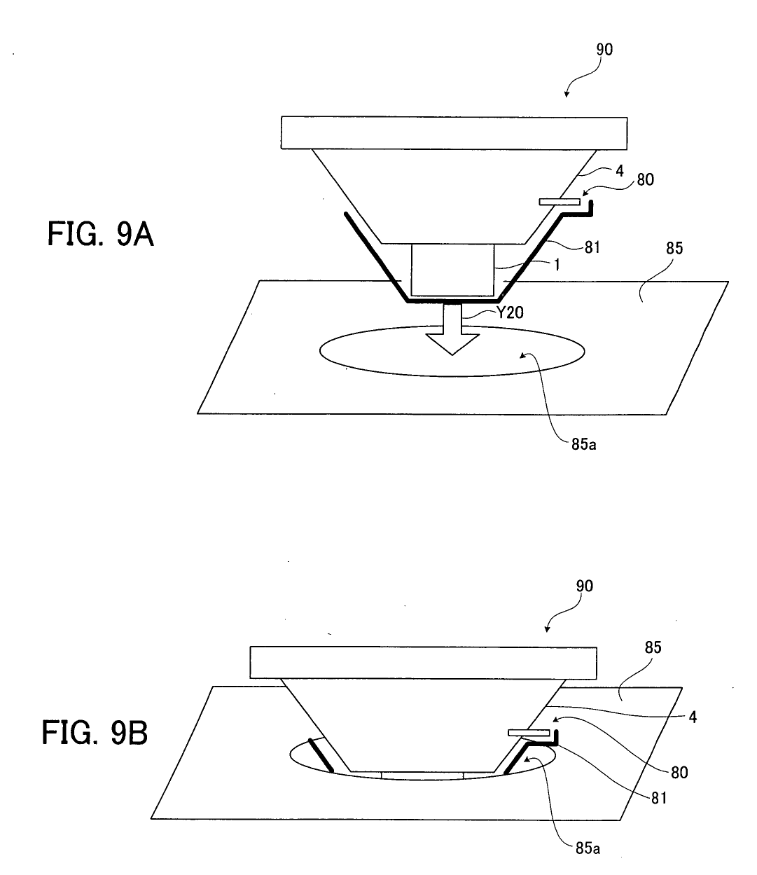

In order to solve the problem, there is proposed a method of protecting the speaker device terminal 80 by covering the rear side of the frame 4, positioned on the side opposite to the sound output direction. By applying the configuration, the speaker device terminal 80 is covered with a cover 81, as shown in FIG. 9A. Therefore, as shown in FIGS. 9A and 9B, at the time of mounting the speaker device 90 on the mounting base 85, when the manufacturer moves the speaker device 90 to the direction of the arrow Y20 and inserts the part of the rear side of the speaker device 90 into the opening 85a of the mounting base 85, even if he or she accidentally hits the vicinity of the speaker device terminal 80 against the mounting base 85, not the speaker device terminal 80 but the cover 81 mechanically collides with the mounting base 85. Namely, the speaker device terminal 80 never mechanically directly collides against the mounting base 85. Thus, such a problem that the speaker device terminal 80 is damaged can be solved. However, in this case, by the amount of the provided cover 81, the component parts of the speaker device increase, and the speaker device becomes heavy. At the same time, the manufacture cost problematically increases.

In this point, in the embodiment, the configuration of the speaker device terminal 50 is improved in order to solve those problems. This point will be explained with reference to FIGS. 2A and 2B, FIGS. 4A to 4C and FIGS. 10A and 10B.

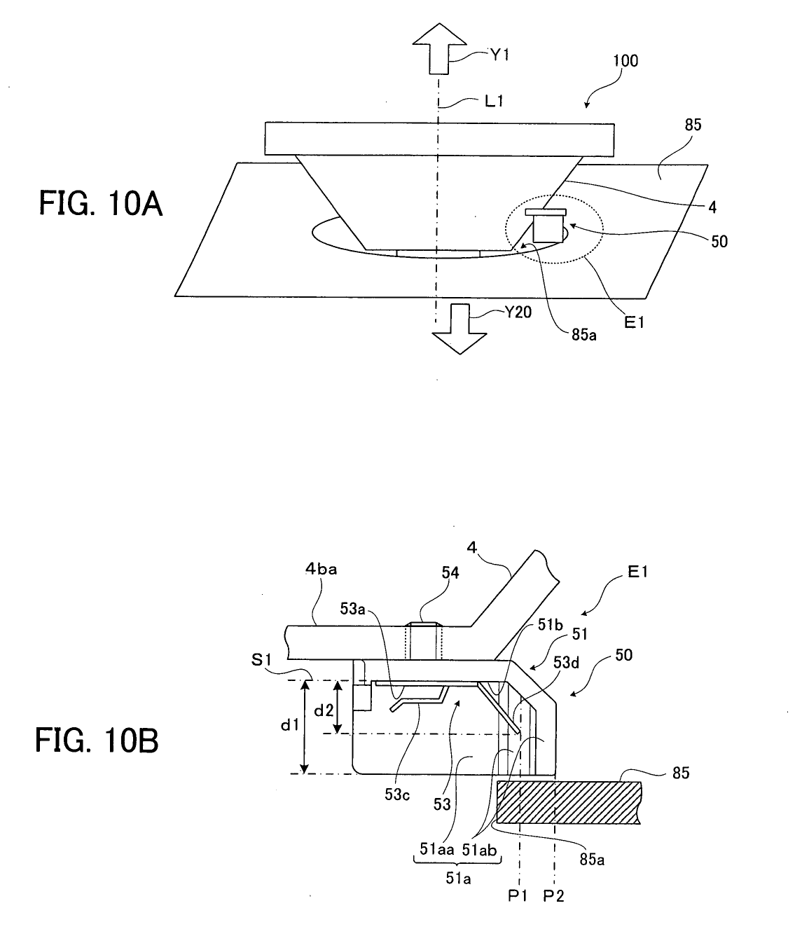

FIG. 10A is a process view schematically showing such a state that the speaker device 100 having the speaker device terminal 50 according to this embodiment is mounted on the mounting base 85. FIG. 10B is a main part side view of the speaker device 100 having the speaker device terminal 50, in which the vicinity of a broken-line area E1 shown in FIG. 10A is enlarged. In FIG. 10A, a straight line L1 shows the central axis of the speaker device 100 including the frame 4.

Concretely, in this embodiment, the speaker device terminal 50 is mounted on the terminal mounting part 4ba of the frame 4 in such a state that the pair of terminal metals 52 and 53 are mounted on the surface of the terminal metal mounting part 51 positioned on the side opposite to the sound output side (the arrow Y1 direction). The terminal metal mounting part 51 being the component of the speaker device terminal 50 has a projecting part (terminal metal protecting part) 51a projecting on the side opposite to the sound output side, and the height d1 of the projecting part 51a in the projecting direction is higher than the height d2 of the pair of terminal metals 52 and 53 in the projecting direction. Namely, in the case that the contact surface of the terminal metal mounting part 51 contacting with the pair of terminal metals 52 and 53 is prescribed as the reference surface S1, the height d1 to the one end of the projecting part 51a positioned at the position farthest in the projecting direction from the reference surface S1 is higher than the height d2 to each end of the pair of terminal metals 52 and 53 positioned at the position farthest in the projecting direction from the reference surface S1.

Thereby, if the manufacturer moves the rear side of the speaker device 100 positioned on the side opposite to the sound output side (the arrow Y1 direction) to the side of the mounting base 85 such as the inner panel of the vehicle and inserts the part of the rear side into the opening 85a provided on the mounting base 85, even when he or she accidentally hits the speaker device terminal 50 against the mounting base 85 at the time of mounting the speaker device 100 on the mounting base 85, not the pair of terminal metals 52 and 53 but the projecting part (terminal metal protecting part) 51a mechanically collides with the mounting base 85. Therefore, it can be prevented that the pair of terminal metals 52 and 53 serving as the relay terminal electrically connected to the voice coil 6 and the amplifier are damaged. In this manner, the projecting part (terminal metal protecting part) 51a has the function to protect the pair of terminal metals 52 and 53 from mechanical collision. Hence, even when the mechanical collision between the speaker device terminal 50 and the mounting base 85 occurs, it can be prevented that the pair of terminal metals 52 and 53 having the important function to transmit the sound signal from the amplifier to the voice coil 6 are crucially damaged.

Additionally, by employing the configuration, the cover for protecting the speaker device terminal 50 becomes unnecessary. Thus, by the amount, the component of the speaker device 100 can be reduced, and accordingly, it can be prevented that the speaker device 100 becomes heavy. Further, as a secondary effect, since the configuration for protecting the speaker device terminal 50 does not have to be formed on the frame 4, the configuration of the terminal mounting part 4ba of the frame 4 can be simplified, and the configuration of the metal mold for forming the frame can be accordingly simplified.

In addition, in this embodiment, as understood with reference to FIG. 1B and FIG. 10B, the relative positional relation between the end part of the projecting part (terminal metal protecting part) 51a and each end part of the pair of terminal metals 52 and 53 is defined so that the end part (a part positioned at P2) of the projecting part (terminal metal protecting part) 51a positioned at the position outwardly farthest from the central axis L1 passing through the center of the frame is positioned on the outer side with respect to each end part (a part positioned at P1) of the pair of terminal metals 52 and 53 positioned at the position outwardly farthest from the central axis L1 passing through the center of the frame.

Therefore, even when the manufacturer accidentally hits the speaker device terminal 50 against the mounting base 85 at the time of mounting the speaker device 100 on the mounting base 85 by the above-mentioned method, since the component of the speaker device terminal 50 mechanically colliding with the mounting base 85 is not the pair of terminal metals 52 and 53 but the projecting part (terminal metal protecting part) 51a, it can be prevented that the pair of terminal metals 52 and 53 serving as the relay terminal electrically connected to the voice coil 6 and the amplifier are damaged.

Now, there is assumed the speaker device terminal according to the comparative example, in which the relative positional relation between the end part of the projecting part (terminal metal protecting part) 51a and each terminal part of the pair of terminal metals 52 and 53 is defined so that the end part of the projecting part (terminal metal protecting part) 51a positioned at the position outwardly farthest from the central axis L1 passing through the center of the frame is positioned on the inner side with respect to each end part of the pair of terminal metals 52 and 53 positioned at the position outwardly farthest from the central axis L1 passing through the center of the frame. In the comparative example, when the manufacturer accidentally hits the speaker device terminal against the mounting base 85 at the time of mounting the speaker device on the mounting base 85, the mechanical collision between the mounting base 85 and the pair of terminal metals 52 and 53 may occur. In this case, the pair of terminal metals 52 and 53 may be damaged.

In a preferred example, the terminal metal mounting part 51 is preferably made of the resin material. If the terminal metal mounting part 51 is made of the resin material, the projecting part (terminal metal protecting part) 51a can be easily formed by a general manufacturing method of the resin manufacture.

### [Modification]

In the present invention, the components of the speaker device terminal 50 including the projecting part (terminal metal protecting part) 51a are deformable within the range of the contents. Namely, the shapes of the components are not limited.

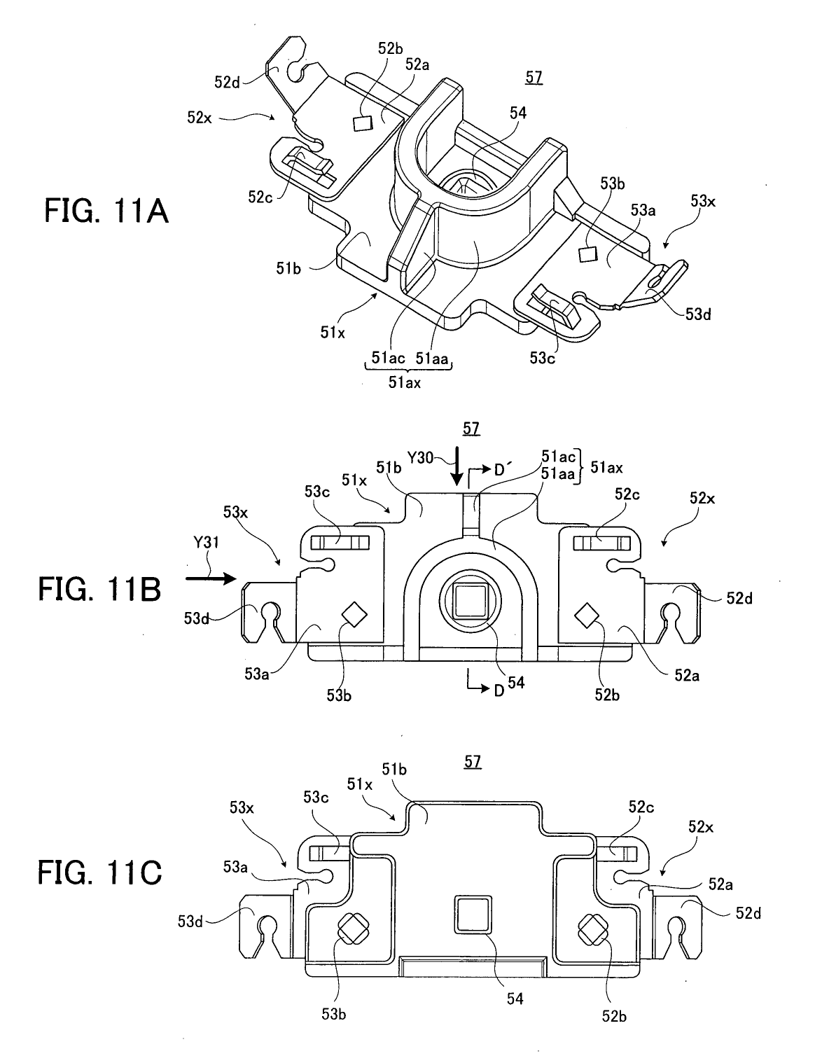

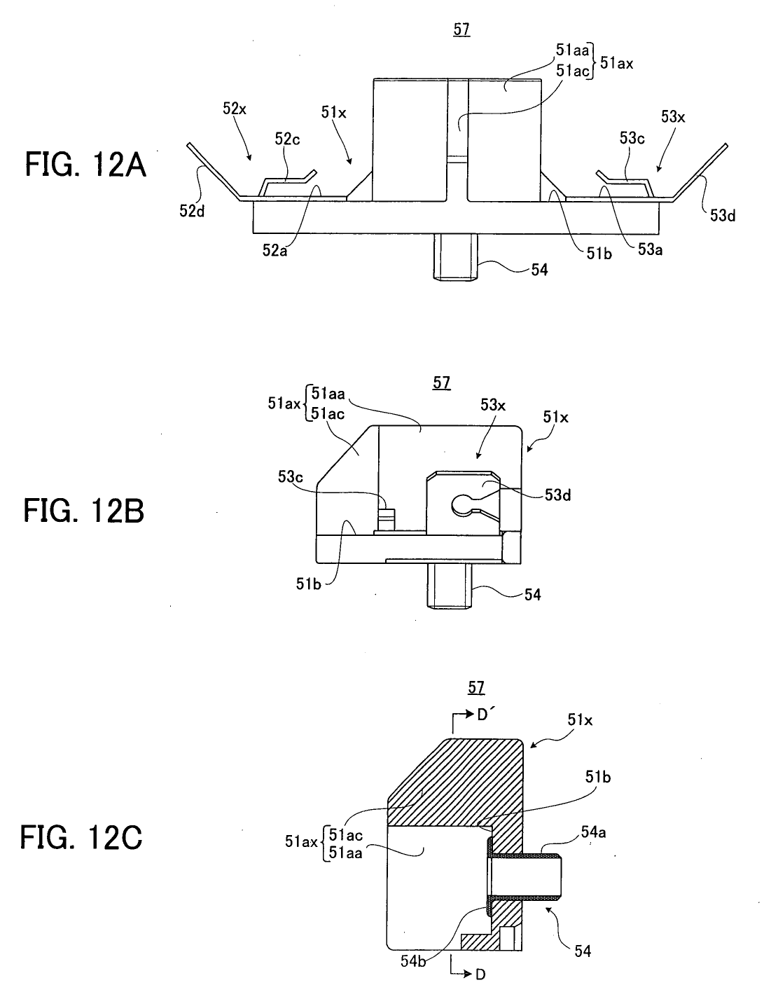

Now, the component of the speaker device terminal according to a modification in which the projecting part 51a and the pair of terminal metals 52 and 53 are deformed will be briefly explained, with reference to FIGS. 11A to 11C and FIGS. 12A to 12C. Hereinafter, the same reference numerals are given to the same components as those of the above-mentioned speaker device terminal 50, and explanations thereof are simplified or omitted.

FIG. 11A shows a perspective view of a speaker device terminal 57 according to the modification. FIG. 11B shows a front view of the speaker device terminal 57 according to the modification. FIG. 11C shows a rear view of the speaker device terminal 57 according to the modification. FIG. 12A shows a side view of the speaker device terminal 57 according to the modification when observed from the direction of an arrow Y30 shown in FIG. 11B. FIG. 12B shows a side view of the speaker device terminal 57 according to the modification when observed from the direction of an arrow Y31 shown in FIG. 11B. FIG. 12C is a main part cross-sectional view of the speaker device terminal 57 taken along a cutting line D-D′ shown in FIG. 11A, and it also shows the main point cross-sectional view of the speaker device terminal 57 cut at the position passing through the center in the longitudinal direction thereof.

When the above-mentioned speaker device terminal 50 and the speaker device terminal 57 according to the modification are compared, they are different in the shapes of the projecting part (terminal metal protecting part) and the pair of terminal metals, but they are same in other components.

A projecting part (terminal metal protecting part) 51ax provided at a terminal metal mounting part 51x of the speaker device terminal 57 includes the first projecting part 51aa having the above configuration and a second projecting part 51ac formed into a shape different from the above-mentioned second projecting part 51ab. In a preferred example, the terminal metal mounting part 51x is preferably made of the resin material. The second projecting part 51ac projects from the base part 51b, and it is provided at a position integrated with the part of the first projecting part 51aa. The second projecting part 51ac has a straight-line plan view and a substantially triangle cross-section.

Meanwhile, a pair of terminal metals 52x and 53x are made of the metallic material, and they have symmetrical shapes. The terminal metal 52x has the same components as those of the above terminal metal 52, but the relative positional relation between the first connection part 52c and the second connection part 52d of the terminal metal 52x is different from the relative positional relation between the first connection part 52c and the second connection part 52d of the terminal metal 52. Similarly, the terminal metal 53x has the same components as those of the above terminal metal 53, but the relative positional relation between the first connection part 53c and the second connection part 53d of the terminal metal 53x are different from the relative positional relation between the first connection part 53c and the second connection part 53d of the terminal metal 53.

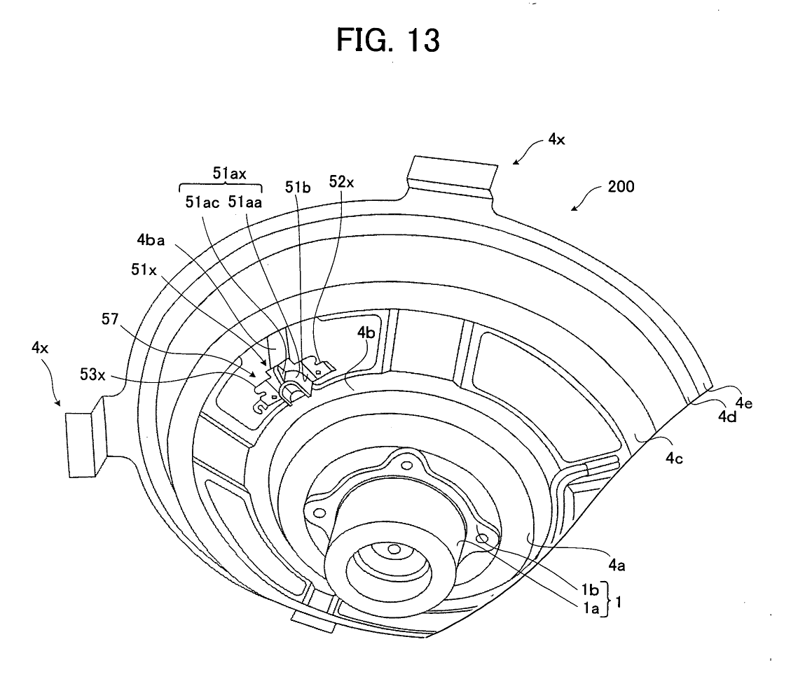

FIG. 13 shows such a state that the speaker device terminal 57 according to the modification having the configuration is mounted on the terminal mounting part 4ba of the frame 4. FIG. 13 shows a main part perspective view of a speaker device 200 having the speaker device terminal 57 according to the modification, corresponding to the comparative example in FIG. 7.

In the speaker device terminal 57 according to the modification, the relative heights and lengths of the projecting part 51ax and the pair of terminal metals 52x and 53x and the positional relation between the frame 4 and the speaker device terminal 57 are designed to satisfy the contents of the above-mentioned invention. Hence, the above operation and effect of the present invention can be obtained.

Namely, in the modification, in such a state that the pair of terminal metals 52x and 53x are mounted on the surface of the terminal metal mounting part 51x positioned on the side opposite to the sound output side, the speaker device terminal 57 is mounted on the terminal mounting part 4ba of the frame 4. The terminal metal mounting part 51x being the component of the speaker device terminal 57 has the projecting part (terminal metal protecting part) 51ax projecting on the side opposite to the sound output side, and the height of the projecting part 51ax in the projecting direction is higher than the heights of the pair of terminal metals 52x and 53x. Namely, in a case that the contact surface of the terminal metal mounting part 51x contacting the pair of terminal metals 52x and 53x is prescribed as the reference surface, the height to the end part of the projecting part 51ax positioned at the position farthest in the projecting direction from the reference surface is higher than the height d2 to each one end of the pair of terminal metals 52x and 53x positioned at the position farthest in the projecting direction from the reference surface. In addition, the relative positional relation between the end part of the projecting part (terminal metal protecting part) 51ax and each one end part of the pair of terminal metals 52x and 53x is defined so that the end part of the projecting part (terminal metal protecting part) 51ax positioned at the position outwardly farthest from the central axis L1 passing through the center of the frame 4 is positioned on the outer side with respect to each end part of the pair of terminal metals 52x and 53x positioned at the position outwardly farthest from the central axis L1 passing through the center of the frame 4. Thereby, the same operation and effect as those of the above-mentioned embodiment can be obtained.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2006-137339 filed on May 17, 2006 including the specification, claims, drawings and summary is incorporated herein by reference in its entirety.

What is claimed is:

1. A speaker device comprising:
a speaker device terminal including a pair of terminal metals and a terminal metal mounting part on which the pair of terminal metals are mounted; and
a frame including a terminal mounting part on which the speaker device terminal is mounted,
wherein the terminal mounting part is provided at a part of the frame positioned on a side opposite to a sound output side,
wherein the speaker device terminal is mounted on the terminal mounting part in such a state that the pair of terminal metals are mounted on the terminal metal mounting part positioned on the side opposite to the sound output side,
wherein the terminal metal mounting part has a terminal metal protecting part projecting on the side opposite to the sound output side, and
wherein a height of the terminal metal protecting part in the projecting direction is higher than heights of the pair of terminal metals in the projecting direction.

2. The speaker device according to claim 1,
wherein, in a case that a contact surface of the terminal metal mounting part contacting the pair of terminal metals is prescribed as a reference surface, a height from the reference surface to one end of the terminal metal protecting part positioned at a position farthest in the projecting direction is higher than a height from the reference surface to each one end of the pair of terminal metals positioned at a position farthest in the projecting direction.

3. The speaker device according to claim 1,
wherein a relative positional relation between the end part of the terminal metal protecting part and each end part of the pair of terminal metals is defined so that the end part of the terminal metal protecting part positioned at a position outwardly farthest from a center of the frame is positioned on an outer side with respect to each end part of the pair of terminal metals positioned at a position outwardly farthest from the center of the frame.

4. The speaker device according to claim 1, wherein the terminal metal mounting part is made of a resin material.
